(19) United States
(12) Patent Application Publication
(10) Pub. No.: US 2008/0222263 A1
(43) Pub. Date: Sep. 11, 2008

(54) METHOD AND SYSTEM FOR MOBILE EMAIL ADAPTATION

(75) Inventors: Lingyan WU, Shenzhen (CN); Xiaolu YAN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/123,080

(22) Filed: May 19, 2008

Related U.S. Application Data
(63) Continuation of application No. PCT/CN2006/002837, filed on Oct. 24, 2006.

(30) Foreign Application Priority Data
Nov. 19, 2005 (CN) 200510101683.0

(51) Int. Cl. G06F 15/16

(52) U.S. Cl. 709/206

(57) ABSTRACT

The present invention discloses a method and system for mobile email adaptation, which sets an adaptation server separated from the mail proxy server, while a mobile email server can ask the adaptation server to fulfill the adaptation function for the content of the mail. Therefore, the adaptation function is stripped from the mail proxy server, the burden on the proxy server is decreased, and the possible bottleneck of the system is avoided. And the adaptation is concentrated in the adaptation server of the mobile email server end, instead of being distributed into each proxy server. So it is more convenient for concentrative manage and function upgrade. As a plurality of mobile email servers could access the same adaptation server, the network organization is more convenient and flexible.

### CROSS-REFERENCE TO RELATED APPLICATIONS

This application is a continuation of International Patent Application No. PCT/CN2006/002837, filed Oct. 24, 2006, which claims priority to Chinese Patent Application No. 200510101683.0, filed Nov. 19, 2005, entitled “ADAPTING METHOD AND SYSTEM FOR MOBILE MAIL TERMINAL,” both of which are hereby incorporated by reference in their entirety.

### FIELD OF THE INVENTION

The present invention relates to communication technology and more particularly to a method and system for mobile email adaptation.

### BACKGROUND OF THE INVENTION

With the development of mobile communication technology, application of the Internet has been widely extended to mobile communication field. The third generation mobile communication technology accelerated the convergence of the telecom network and the Internet. The extension of the Internet application to the mobile network expands the service capability of mobile network, but the inherent characteristics of the mobile network raises new requirement for these applications. Email is playing an important role in the application of the Internet. The mobile email service is the extension of conventional Internet email, which supports editing, receiving and sending email through a mobile terminal, and may perform seamless convergence with email service of the Internet.

The mobile email service mentioned above is an application for safely accessing email server through wireless access manner and performing corresponding processing for the information. With the development of mobile data service, terminals adapted for various services are characterized by diversity. Network equipment has to inevitably confront diverse terminals. In the meantime, in order to improve user loyalty and user experience, it will become a certain trend of service operation to provide individualized service for users. The diversity of mobile terminals and the differentiation of the software and hardware platform of mobile terminals need the service provider to adapt the content to achieve a maximal matching for the terminals when the service provider provides service. In addition, individualization demand becomes more and more intense when a mobile user subscribes to the service. This requests the operator and the service provider to provide individualized service for users. The individualized customization demand for the content pages of service is usually included.

In a word, in order to support the mobile terminal to send or receive email and seamlessly converge with the email service of the Internet, the following problems should be solved firstly: the display of email pictures (format, size, color bit), the display of mail text attachments (formats of files with diverse category, big mail), and the individualized display based on a user terminal. All of these should be adapted according to the capability of the mobile terminal so as to be smoothly displayed in the mobile terminal.

A method for realizing email adaptation function discussed in “Explore of Service Model Based on Storage and Forward” (Lin Wenhong, ASPire Digital Technologies (Shenzhen) Co., Ltd., CHINA DATA COMMUNICATIONS, APR. 2005, No. 4) includes: introducing a mail proxy server serving as a front-end equipment of each mail server and realizing the adaptation in the proxy server. As shown in FIG. 1, the flow of the traffic mode is as follows.

Step a) A user A, via a terminal like a mobile phone, or a computer, sends a mail to a mail server, where the mail is to be sent to a user B.

Step b) The mail server sends an arrival notification of new mail to the user B;

Step c) The user B sends a mail request to a mail proxy server via the current terminal.

Step d) The mail proxy server transfers the mail request to the mail server via the protocol of Post Office Protocol 3 (POP3) or the Simple Mail Transfer Protocol (SMTP).

Step e) The mail server sends the requested mail to the mail proxy server;

Step f) The mail proxy server adapts the mail according to the capability set information in the mail request of the user B.

Step g) The mail proxy server sends the adapted mail to the user B.

This provides a method for realizing an email adaptation function has the following disadvantages. The regular mail proxy function and the adaptation function are both achieved in the mail proxy server because the mail proxy server is located between the mail server and a client. This may become the system bottleneck in some cases. Besides, it is not convenient for centralized management and upgrading because the adaptation is achieved in every mail proxy server.

### SUMMARY OF THE INVENTION

The object of the present invention is to provide a method and system for mobile email adaptation to solve the problem of system bottleneck easily happening in the prior art and the inconvenience for centralized management and upgrading.

In order to accomplish the above object, the present invention provides a method for mobile email adaptation, including following steps.

A mobile email server receives a mail request from a terminal;

The mobile email server acquires capability set information of the terminal according to the mail request;

The mobile email server sends the capability set information and the requested mail to an adaptation server;

The mobile email server receives an adapted mail, wherein the adapted mail is adapted according to the capability set information and returned by the adaptation server which performs adaptation for the mail; and

The mobile email server sends the adapted mail to the terminal.

In the method mentioned above, the mobile email server preliminarily judges whether the mail needs to be adapted according to the capability set information; and directly sends the requested mail to the terminal if the mail does not need to be adapted.

In the method mentioned above, the preliminary judgment is about whether the sending terminal of the mail and the terminal are the same type of terminal; and the adaptation is not needed if the sending terminal of the mail and the terminal are the same type of terminal.

In the method mentioned above, the mobile email server judges whether the requested mail has portions needing to be adapted according to the capability set information; the mobile email server directly sends the mail to the terminal if there is not portion needing to be adapted; and the mobile email sever sends the portion needing to be adapted and the capability set information to the adaptation server if there are portions needing to be adapted. The adaptation server performs adaptation for the portions needing to be adapted according to the capability set information and returns the adapted portion back.

In the method mentioned above, the mobile email server acquires the capability set information of the terminal according to the uniform resource identifier in the mail request.

In the method mentioned above, the adaptation server judges whether the content of the mail needs to be adapted before performing the adaptation for the mail according to the capability set information.

In the method mentioned above, the step of judging whether the content of the mail needs to be adapted by the adaptation server includes any one or more of the following: judging whether the terminal is compatible with the attachment format of the mail, judging whether the terminal is compatible with the size of the mail, judging whether the terminal is compatible with the multimedia information contained in the mail.

In order to accomplish above object, the present invention further provides a system for mobile email adaptation, including: a mobile email server configured to be capable of communicating with an adaptation server and receive a mail request sent by a terminal, acquire capability set information of the terminal according to the mail request, send the capability set information and requested mail to an adaptation server, receive an adapted mail, wherein the adapted mail is adapted according to the capability set information and returned by the adaptation server which performs adaptation for the mail, and send the adapted mail to the terminal;

The adaptation server is configured to receive the capability set information and the requested mail sent by the mobile email server, perform adaptation for the mail according to the capability set information, and return the adapted mail back to the mobile email server.

In the system mentioned above, the adaptation server is connected with a plurality of mobile email servers.

In order to accomplish above objects, the present invention further provides a mobile email server, including:

a module configured to receive a mail request sent by a terminal;

a module configured to acquire capability set information of the terminal according to the mail request;

a module configured to send the capability set information and requested mail to an adaptation server;

a module configured to receive the adapted mail, wherein the adapted mail is adapted according to the capability set information and returned by the adaptation server which performs adaptation for the mail; and

a module, configured to send the adapted mail to the terminal.

By adopting above-mentioned technical solution, the present invention may achieve following advantages:

1) In the present invention, the adaptation function is realized by being concentrated in the adaptation server which is separated from the mail proxy server, while the mobile email server can ask the adaptation server to fulfill the adaptation function for the content of the mail. It is convenient for the centralized management. The adaptation upgrading for the whole system can be simply completed in AS. This is equivalent to provide a uniform mail adaptation service entity and interface for terminals and other servers, e.g. mail proxy servers located at every enterprise, provide a much more effective approach for the interaction and share, and meet the need of fast increase of network mail information. Furthermore, in practical application, a plurality of mobile email servers may access the same adaptation server. The network organization becomes more flexible and convenient. The corresponding configuration and optimization may be performed according to the specific demand of mail information and the network information flow to further improve the operation efficiency of the system.

2) In the present invention, the adaptation function is stripped from the mail proxy server of the prior art to make the mail proxy server only perform the conventional mail proxy function from the mobile email server to the terminal so as to effectively reduce the burden of the mail proxy server and avoid the system bottleneck in the prior art. Furthermore, repeated configuration for the same adaptation function resource is avoided by stripping the function from numerous mail proxy servers in the prior art. To a large extent, the present invention optimizes the whole resource configuration of the society and has good economy and society benefit.

The present invention will be described in more detail with reference to the drawings and embodiments.

### BRIEF DESCRIPTION OF THE DRAWINGS

FIG. 1 is a schematic diagram illustrating a traffic model of a method for mobile email adaptation;

FIG. 2 is a schematic diagram illustrating a system for realizing the adaptation of the mobile email in accordance with the present invention;

FIG. 3 is a schematic diagram illustrating a traffic flow of a mobile email in accordance with the present invention;

FIG. 4 is a schematic diagram illustrating a signaling flow of a mobile email in accordance with the present invention.

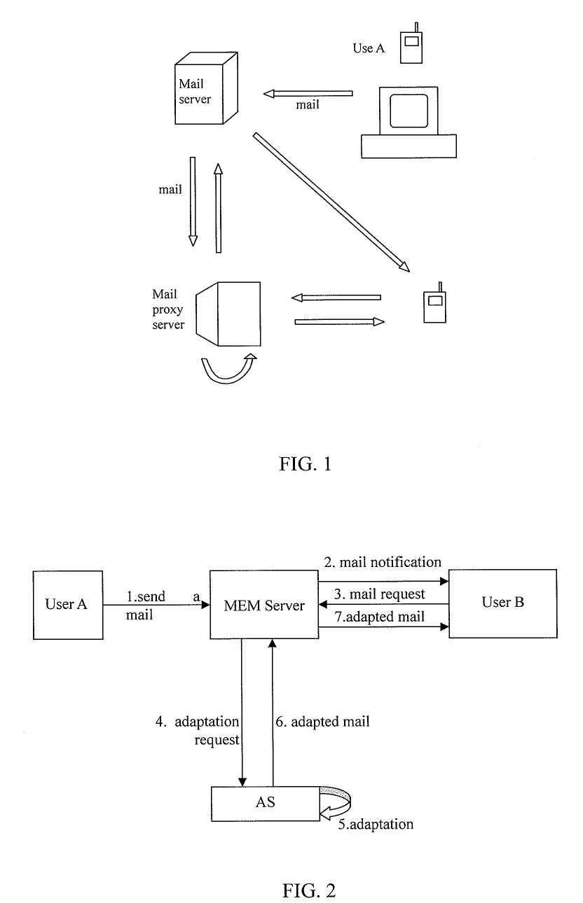

### DETAILED DESCRIPTION OF THE PREFERRED EMBODIMENTS

As shown in FIG. 2, the present invention includes a mobile email server (MEM Server) and an adaptation server (AS). The adaptation server performs information interaction with the mobile email server, judges the adaptation capability of a mail according to the capability set information, fulfills the corresponding adaptation and returns the adapted mail to the mobile email server. The mobile email server receives a mail request from a receiving terminal, acquires an user agent profile (UAprofile) (in this invention, UAprofile is specifically taken as an example of capability set information) of the receiving terminal, sends the UAprofile and the related mail to the adaptation server, and sends the adapted mail to the receiving terminal. Furthermore, the mobile email server can fulfill a preliminary judgment for the mail adaptation according to the UAprofile. For the sake of clear illustration, the mail proxy server between the mobile email server and the user B, simply adapted to complete the conventional mail proxy function, is omitted in the drawings and following descriptions.

The mobile email server, serving as the core equipment for receiving and sending mails, needs to complete the functions of a conventional mail server as follows: receiving the mail sent by the mail sender, i.e. the user A and sending an arrival notification of new mail to the mail receiver, i.e. the user B. The mobile email server also needs to complete the following: receiving the mail request including a uniform resource identifier (URI) in the request information thereof sent by the user B; acquiring the UAprofile according to the URI of the receiving terminal; sending the requested mail and the UAprofile to the adaptation server; receiving and sending the adapted mail. The mobile email server may also have the ability to judge whether the requested mail needs to be adapted, and if it's judged that portion of the requested mail needs to be adapted, the portion, needing to be adapted, of the requested mail and the UAprofile may be sent to the adaptation server

The adaptation server may be configured to complete the adaptation function of a mail, perform the adaptation for the mail or portion of the mail (if what the mobile email server sends is portion of the email) according to the UAprofile transferred by the mobile email server, and return the adapted mail or portion of the mail to the mobile email server. The adaptation sever may also have the ability to judge whether the requested mail needs to be adapted and adapt the mail only after judging that the requested mail needs to be adapted. The content of the mail adaptation completed by the adaptation server may be text adaptation, and/or picture adaptation and/or attachment adaptation according to practical demand.

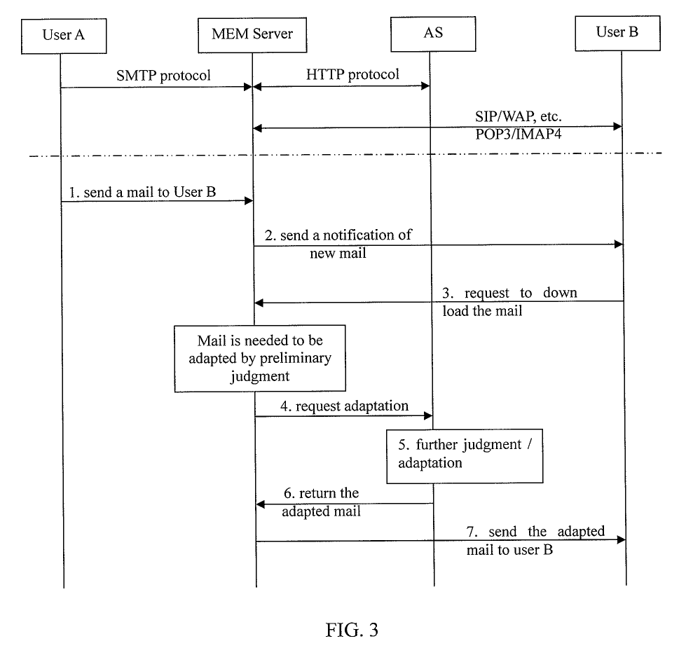

Accompanying FIG. 2 and FIG. 3, the realization process of a method for mobile email adaptation in accordance with the present invention is described in detail by describing the flow of mobile email traffic.

I. one mail from the user A to the user B arrives at the mobile email server. The communication may adopt the protocol of SMTP;

II. the mobile email server sends a notification to the user B to inform the user B that a new mail has arrived. The notification may adopts the notice manner of an inband notification (mobile e-mail protocol), an outband notification (SMS or WAP or SIP Push);

III. the user B initiates a mail request to the mobile email server to request to download the entire or portion of the content of the mail. The request information includes the URI of the receiving terminal. The request may be based on the mail protocol of POP3/IMAP4;

IV. the mobile email server acquires the UAprofile information of the receiving terminal according to the URI of the receiving terminal, preliminarily judges whether the mail to be downloaded needs to be adapted. The preliminary judgment may include judging the content that whether the sending terminal and the receiving terminal are the same type of mobile terminal. The specific content of judgment may be adjusted and modified according to practical need.

If the preliminary judgment shows that the content of the mail does not need to be adapted, for example, the type of the sending terminal is the same as the type of the receiving terminal, the mobile email server directly sends the mail to the user B. If the judgment shows that the content of the mail needs to be adapted, the mail requested to be downloaded and the UAprofile are sent to the adaptation server together to perform adaptation. The adaptation request may be based on the protocol of HTTP;

V. the adaptation server further judges whether the content of the mail needs to be adapted according to the UAprofile. The further judgment is about whether the receiving terminal is compatible with the content of the mail attachment format, and/or the mail size, and/or the multimedia information contained in the mail text according to the content of the UAprofile including screen size, browser edition. If the receiving terminal is compatible with the content, it's judged that the adaptation is not needed, the adaptation server returns the mail to the mobile email server directly;

If the receiving terminal is not compatible with the content, it's judged that the adaptation is needed. The adaptation server performs corresponding content adaptation for the mail according to the UAprofile, including picture adaptation, text adaptation, and/or attachment adaptation according to practical demand.

VI. the adaptation server returns the adapted mail to the mobile email server. The transmission may be based on the protocol of HTTP;

VII. the mobile email server sends the adapted mail to the user B and stores the original mail in mailbox. Usually, the transmission is based on the mail protocol of POP3/IMAP4, etc.

As a substitute for the method mentioned above, the preliminary judgment process in step IV, performed by the mobile email server for judging whether the mail needs to be adapted, may be omitted. The mail and the UAprofile are directly sent to the adaptation server. The adaptation server directly performs the adaptation, or judges whether the adaptation is needed and performs the adaptation when it's needed. The method decreases the burden of the mobile email server, but may increase the network flow to some extent between the mobile email server and the adaptation server.

As another substitute for the method mentioned above, the further judgment process in step V, performed by the adaptation server for judging whether the mail needs to be adapted, may be moved to step IV and be completed together by the mobile email server, after the mobile email server performs the preliminary judgment. Therefore, the mobile email server may only send the portions needing to be adapted to the adaptation server for adaptation after the further judgment is made so as to decrease the network flow between the mobile email server and the adaptation server. However, this method may cause burden for the mobile email server.

Each method mentioned above has its own advantage. In practical application, the method may be measured and chosen according to the characteristics of practical traffic. It should be noted that the “adaptation server” represents an entity providing the adaptation function in the present invention. The name itself of the entity should not limit the present invention.

In practical operation, the process of information transmission and communication in each step of the present invention may be performed by choosing suitable protocols. The signaling flowchart of the first method mentioned above is described by choosing specific protocols as follows. Other signaling flow for substitution can be inferred similarly. In the mobile email traffic, a mobile email server may send a push notification to a client by many methods (SMS or WAP Push or SIP Push, etc.). The following signaling flows take SIP push as an example. Other methods of push notification may be inferred similarly. Mail receiving protocols have POP, and IMAP, etc. The following signaling flow takes IMAP4 as an example. The signaling flows of other mail receiving protocols may be inferred similarly.

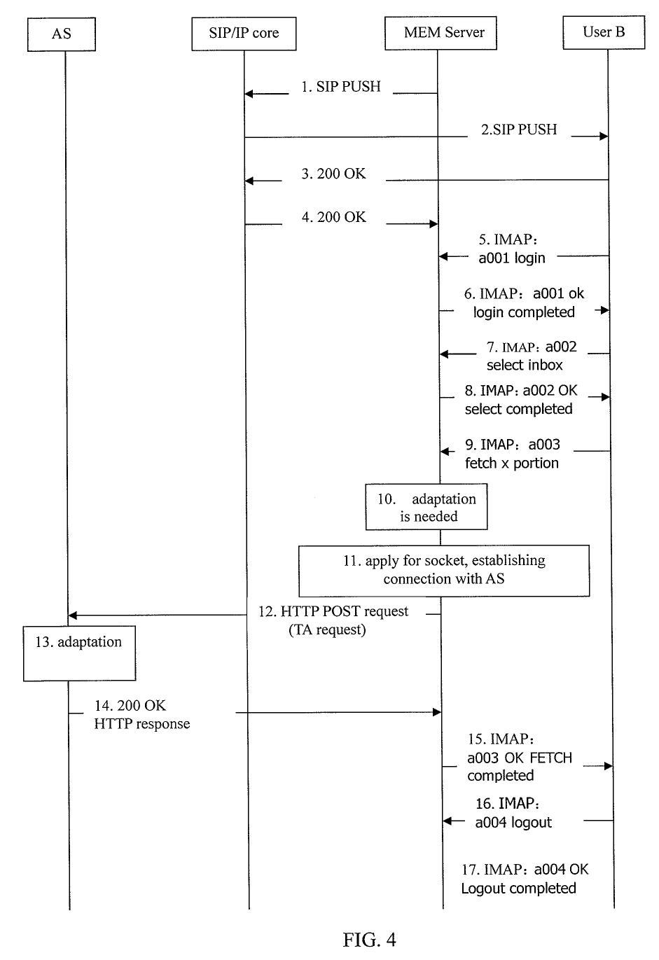

The signaling flowchart in accordance with the present embodiment is shown in FIG. 4.

1. A new mail sent by the user A aiming at the user B arrives at the mobile email server. The mobile email server sends a notification to an SIP/IP Core. The SIP/IP Core is a uniform transmission service network for providing the traffic of routing, authentication, compression, etc. The push notification mentioned here provides function of routing and addressing. SIP/IP signaling is routed between a client and a server.

2. The SIP/IP Core transfers the notification to the user B to notify the user B that a new mail has arrived.

3. The user B sends 200 OK to the SIP/IP Core demonstrating that the above-mentioned push notification has been received.

4. The SIP/IP Core sends 200 OK to the mobile email server.

5. The user B sends a login order to the mobile email server to request login.

6. The mobile email server returns OK LOGIN completed to the user B demonstrating that the login is successful.

7. The user B sends SELECT inbox to the mobile email server to request to choose an inbox for downloading the mail.

8. The mobile email server returns OK SELECT completed to the user B demonstrating that the choosing is completed and it is allowed to download the mail.

9. The user B sends fetch num portion to the mobile email server to request to download the entire or portion of the numth mail. The portion may be full, body [header], and body [text], etc. The URI of the receiving terminal is contained in the request information.

10. The mobile email server acquires the UAprofile of the receiving terminal according to the URI of the receiving terminal and preliminarily judges that the content of the mail to be downloaded needs to be adapted (e.g. the sending terminal and the receiving terminal are not the same type of mobile terminal).

11. The mobile email server applies for a socket to establish the connection between the adaptation server and the mobile email server.

12. The mobile email server sends an adaptation request to the adaptation server. The method in the request line is post.

13. The adaptation server further judges that the adaptation is needed according to the UAprofile and the mail information of the receiving terminal (e.g. the receiving part mobile terminal can not be completely compatible with the attachment format/mail size sent by the sending part) and adapts the content of the mail.

14. The adaptation server returns 200 OK to the mobile email server demonstrating a confirmation and returns HTTP response (with adapted email data). Finally the mobile email server or the adaptation server closes the socket. The TCP/IP session ends.

15. The mobile email server sends Ok FETCH completed demonstrating that the mail has been successfully sent after sending the adapted numth mail to the user B.

16. The user B sends LOGOUT to the mobile email server requesting to end the IMAP conversation.

17. The mobile email server email server sends OK LOGOUT completed to the user B demonstrating the end of the IMAP session of this time.

Though illustration and description of the present disclosure have been given in conjunction with the exemplary embodiments thereof, it should be appreciated by persons of ordinary skill in the art that various changes in forms and details can be made without deviation from the spirit and scope of this disclosure, which are defined by the appended claims.

What is claimed is:

1. A method for mobile email adaptation, comprising:
receiving a mail request from a terminal;
acquiring capability set information of the terminal according to the mail request;
sending the capability set information and the requested mail to an adaptation server;
receiving an adapted mail, wherein the adapted mail is adapted according to the capability set information and returned by the adaptation server which performs adaptation for the mail; and
sending the adapted mail to the terminal.

2. The method according to claim 1, wherein the method further comprises, preliminarily judging, by the mobile email server, whether the mail needs to be adapted according to the capability set information;
sending the capability set information and the requested mail to the adaptation server if the mail needs to be adapted;
directly sending the requested mail to the terminal if the mail does not need to be adapted.

3. The method according to claim 2, wherein the preliminary judgment about whether the sending terminal of the mail and the terminal are the same type of terminal; and the adaptation is not needed if the sending terminal of the mail and the terminal are the same type of terminal.

4. The method according to claim 1, wherein the method further comprises, judging, by the mobile email server, whether the requested mail has portions needing to be adapted according to the capability set information;
sending directly the mail to the terminal if there is not portion needing to be adapted;
sending the portion needing to be adapted and the capability set information to the adaptation server if there are portions needing to be adapted; performing, by the adaptation server, adaptation for the portions needing to be adapted according to the capability set information and returning the adapted portion back.

5. The method according to claim 1, wherein the mobile email server acquires the capability set information of the terminal according to the uniform resource identifier in the mail request.

6. The method according to claim 1, wherein the adaptation server judges whether the content of the mail needs to be adapted before performing the adaptation for the mail according to the capability set information.

7. The method according to claim 6, wherein the step of judging whether the content of the mail needs to be adapted by the adaptation server comprises any one or more of the following: judging whether the terminal is compatible with the attachment format of the mail, judging whether the terminal is compatible with the size of the mail, judging whether the terminal is compatible with the multimedia information contained in the mail.

8. A system for mobile email adaptation, comprising:
a mobile email server configured to be capable of communicating with an adaptation server;
the mobile email server configured to receive a mail request sent by a terminal, acquire capability set information of the terminal according to the mail request, send the capability set information and requested mail to an adaptation server, receive an adapted mail, wherein the adapted mail is adapted according to the capability set information and returned by the adaptation server which performs adaptation for the mail, and send the adapted mail to the terminal; and
the adaptation server configured to receive the capability set information and the requested mail sent by the mobile email server, perform adaptation for the mail according to the capability set information, and return the adapted mail back to the mobile email server.

9. The system according to claim 8, wherein the adaptation server is connected with a plurality of mobile email servers.

10. A mobile email server, comprising:
a module configured to receive a mail request sent by a terminal;
a module configured to acquire capability set information of the terminal according to the mail request;
a module configured to send the capability set information and requested mail to an adaptation server;
a module configured to receive an adapted mail, wherein the adapted mail is adapted according to the capability set information and returned by the adaptation server which performs adaptation for the mail; and
a module configured to send the adapted mail to the terminal.
